(19) United States
(12) Patent Application Publication
(10) Pub. No.: US 2021/0334903 A1
(43) Pub. Date: Oct. 28, 2021

(54) Insurance Application Process Using Multiple Communication Channels

(71) Applicant: STATE FARM MUTUAL AUTOMOBILE INSURANCE COMPANY, Bloomington, IL (US)

(72) Inventors: David Scott Etheridge, Bloomington, IL (US); Gregory K. Sheley, Bloomington, IL (US); Andrew Patrick Wieduwilt, Bloomington, IL (US); Jill A. Eberle, Bloomington, IL (US); Carl R. Streily, JR., Normal, IL (US); Randall P. Petersen, Normal, IL (US); Amy R. Prestegaard, Waynesville, IL (US); Larry J. Ingrum, Mahomet, IL (US); Lori J. Kaufman, Bloomington, IL (US); Alan R. Hendren, Le Roy, IL (US); David A. Theile, Bloomington, IL (US); Douglas K. Sorensen, Bloomington, IL (US)

(21) Appl. No.: 14/699,110

(22) Filed: Apr. 29, 2015

Related U.S. Application Data
(60) Provisional application No. 62/029,102, filed on Jul. 25, 2014.

(51) Int. Cl. G06Q 40/08

(52) U.S. Cl. CPC G06Q 40/08

(57) ABSTRACT

Methods, systems, apparatus, and non-transitory computer readable media are disclosed for providing a common application that allows a customer to submit relevant information across various channels for obtaining insurance policy products. Various aspects include a common application that receives information entered by a customer via one or more customer channels, which may include online channels, call center channels, insurance agent channels, and/or any other suitable channels. Various aspects also include aggregating portions of the relevant customer's information while identifying the channel in which the information was received and information not yet collected to determine an appropriate insurance policy product. In this way, a common application is utilized to provide a full suite of insurance policy products to customers while allowing the customers to submit relevant information over any number of different channels.

### CROSS REFERENCE TO RELATED APPLICATION

This application claims the benefit of U.S. Provisional Patent Application No. 62/029,102 entitled “Insurance Application Process Using Multiple Communication Channels,” filed Jul. 25, 2014, the disclosure of which is hereby expressly incorporated by reference in its entirety.

### TECHNICAL FIELD

The present disclosure relates to systems, methods, apparatus, and non-transitory computer readable media for collecting data for insurance policy enrollment, and, more particularly, to using a common application interface for collecting user data via multiple channels for insurance policy enrollment.

### BACKGROUND

Life insurance is commonly purchased by people to insure themselves or others in the event of a persons' death. Other types of insurance provide protection in accordance with their respective policies, which could include property, such as a person's house or car, for example. To obtain an insurance policy, a customer typically submits information to the insurer, who in turn decides whether to insure the customer, and if so, determines an appropriate premium for the issued insurance policy. The decision of whether to issue an insurance policy, as well as the premiums associated with an insurance policy, is generally based upon several risk factors determined from the submitted information. In the case of property insurance policies, these risk factors are generally determined from the location of the insured property, people who will be operating the insured property, etc. In the case of life insurance policies, the risk factors are typically determined from the customer's lifestyle choices (e.g., tobacco and/or alcohol consumption) the customer's age, present health conditions, family health history, occupation and/or recreational habits, driving history, credit history, and/or other suitable factors for determining a customer's potential risk of death upon issuance of the life insurance policy.

Traditionally, a customer seeking to purchase a life insurance policy visits a local agent's office. A customer may then furnish relevant information to the agent, and the agent may utilize an insurer application program to collect the customer's information. At this time, an agent may typically schedule an appointment for a medical professional (e.g., a registered nurse) to visit the customer's home or office to collect additional medical samples from the customer, such as blood and/or urine samples, which are sent to a laboratory. When the laboratory results are completed, an insurer may utilize this information in conjunction with the originally collected customer information to further adjust the life insurance premiums (or decide to deny coverage) in a process known as medical underwriting.

Since visiting an agent's office is often time consuming and inconvenient, some insurers allow a customer to start an insurance application process over alternate channels, such as through a telephone call center or a web-based online application process. But allowing customers to apply for insurance via these alternate channels has several drawbacks. First, a customer may start the process using one channel (e.g., online) but then choose, or be directed to complete the remainder of the application process via another channel, such as over the phone or by visiting an agent's office, which is typically the case for life insurance policies. These new channels may not be in sync with the information the customer has already entered, causing a customer to repeat this information and/or re-enter it, leading to wasted time and frustration.

Second, many insurance policies, such as life insurance policies, provide varying levels and/or tiers of products. By allowing a customer to apply for insurance online or over the phone, an insurer may miss out on “up-selling” a customer to a better tier of coverage, as an agent would ordinarily be trained to do.

Third, agents, telephone call centers, and online applications use different means of collecting customer information, and thus synchronizing collected information among these three customer channels presents complications. Therefore, ensuring that a customer can use various channels to obtain insurance coverage while maintaining a personalized level of service for each customer presents several challenges.

### BRIEF SUMMARY

In some aspects, methods, systems, apparatus, and non-transitory computer readable media are described that may, inter alia, allow a customer to submit relevant information across various channels to obtain a quote for one or more insurance policy products. In such aspects, information is received from a customer and/or agent via one or more channels, which may include online channels, call center channels, and insurance agent channels. In such aspects, the data may be aggregated as it is received to build a customer profile, and as the data is received a determination may be made regarding whether the aggregated data constitutes a complete customer profile for the purposes of quoting an insurance policy product. Data within the profile may be flagged and/or otherwise labeled to identify the channel from which it was received.

In additional aspects, methods, systems, apparatus, and non-transitory computer readable media are described regarding a common application interface that is implemented for each channel such that the online channel, the call center channel, and the insurance agent channel each presents an identical (or nearly identical) application interface to each respective user. In such aspects, the common application interface may allow a customer to inquire about a full suite of insurance policy products while allowing the customers to submit any relevant information over any combination of the different channels to obtain an insurance policy product quote.

In one aspect, a computer-implemented method for collecting information for issuance of a life insurance policy may be provided. The method may include (1) receiving, by one or more processors, a first portion of customer information entered via a first application from a first channel; (2) receiving, by one or more processors, a second portion of customer information entered via a second application from a second channel; (3) aggregating, by one or more processors, the first and second portion of customer information to generate an aggregated customer policy profile; and (4) determining, by one or more processors, a life insurance policy based upon the aggregated customer policy profile. The first and the second application may be identical or similar web-based applications, and/or virtual insurance applications. The method may include additional, fewer, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

There are shown in the drawings arrangements which are presently discussed, it being understood, however, that the present embodiments are not limited to the precise arrangements and instrumentalities shown, wherein:

FIG. 1 is a block diagram of an exemplary cross channel process 100 for collecting insurance information from a customer;

FIG. 2 is a block diagram of an exemplary cross channel network 200; and

FIG. 3 illustrates an exemplary method 300.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to, inter alia, providing a cross channel acquisition process for insurance and/or financial-related products and/or other suitable products and/or services. A computer-implemented method of generating and/or selling insurance products and/or services may include allowing potential customers to initiate changes to current or new insurance policies or products at various access points or channels. Information necessary to issue an insurance policy may be collected from a customer (or potential customer) during multiple interactions with the customer occurring at multiple access points or channels.

In one aspect, an integrated insurance (or financial-related) application may be provided. For instance, a single virtual insurance application may be used in multiple customer channels, such as an online channel, an agent channel, and/or a call center channel. All three customer channels may readily assist a customer, adding value to the customer experience. Each channel may allow the customer to purchase one or more types of insurance products and/or services (e.g., auto, life, health, and/or home insurance), and/or financial-related products (e.g., auto or personal loans).

The integrated insurance application (e.g., a virtual or computer generated application for insurance products and/or services) may be started in one customer channel and completed in another. For instance, the integrated insurance application may be started via a call center and then completed online, or started online and then completed in person by meeting with an agent. The integrated insurance application may provide the customer (or potential customer) with the flexibility to choose how they would like to apply for insurance, enhancing their purchasing experience. The integrated insurance application may allow the customer to access varying channels at different times based upon their individual needs and expectations.

The cross channel functionality of the integrated insurance application may give the customer the choice of what channel they want to complete an application for insurance in. A common application, such as a common virtual or computer generated application, may be used across each of the channels, leading to uniformity among the service channels. The common application may permit an agent to more easily assist customers and/or sell or offer additional insurance products or services to the customer. The same or similar application experience may result regardless of what combination of channels is utilized to complete the insurance application.

### I. Exemplary Cross Channel Information Collection Process

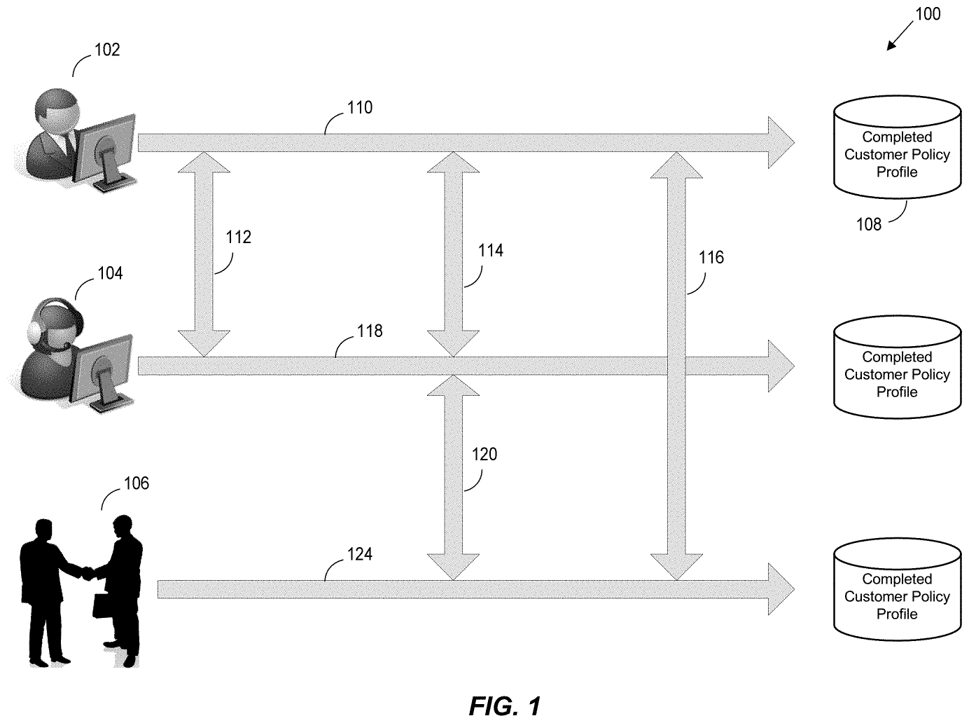

FIG. 1 is a block diagram of an exemplary cross channel process 100 for collecting insurance information from a customer. Cross channel process 100 includes a completed customer policy profile 108 that is generated from information received via one or more of a customer channel 110, a call center channel 118, and/or an agent channel 124. In the present aspect, a customer may enter any suitable information that may be used for the selection and determination of a particular insurance policy via any of customer channel 110, call center channel 118, and agent channel 124 using a respective channel interface, which may then be used to build the completed customer policy profile 108.

As shown in FIG. 1, a customer entering information via customer channel 110 may utilize customer channel interface 102. Furthermore, a customer entering information via call center channel 104 may utilize (or work with an operator who in turn utilizes) call center interface 104. Additionally, a customer entering information via agent channel 124 may utilize (or work with an agent who in turn utilizes) channel interface 106.

In the present aspects, each of customer channel interface 102, call center interface 104, and agent channel interface 106 may be implemented as any suitable computing device configured to collect customer information. For example, each of customer channel interface 102, call center interface 104, and agent channel interface 106 may be implemented as any suitable type of computing device such as a user equipment (UE), a mobile device, a computer, laptop, tablet, desktop, wearable electronic devices, etc.

In the present aspect, each of customer channel interface 102, call center interface 104, and agent channel interface 106 may be configured to execute software such as one or more programs, applications, etc., to facilitate the collection of customer information. In some of the present aspects, any combination of customer channel interface 102, call center interface 104, and agent channel interface 106 may store and execute software locally, i.e., software that is stored in the respective interface device. In some of the present aspects, any combination of customer channel interface 102, call center interface 104, and agent channel interface 106 may execute software that is installed on a remote device, such as a server, for example. In yet other present aspects, any combination of customer channel interface 102, call center interface 104, and agent channel interface 106 may execute software locally while other interfaces execute software from a remote device. Furthermore, the present aspects may include any of customer channel interface 102, call center interface 104, and agent channel interface 106 executing both locally stored software and remotely accessed software that work in conjunction with one another to generate completed customer policy profile 108. A remote device is not shown in FIG. 1 for purposes of brevity.

In the present aspects in which local software execution is implemented, any of customer channel interface 102, call center interface 104, and/or agent channel interface 106 may download, install, and/or execute an application and/or program that facilitates the collection of customer information and sending of this information to a remote device, such as a server, for example. The remote device may, in turn, generate completed customer policy profile 108. Local software aspects may be particularly useful, when, for example, the interface is a mobile device, as a mobile-specific application may provide a customer with a convenient means of data entry tailored to that device.

In remote software execution aspects, any of customer channel interface 102, call center interface 104, and agent channel interface 106 may communicate with a remote device and collect customer information in accordance with one or more applications and/or programs residing on the remote device. For example, any of customer channel interface 102, call center interface 104, and agent channel interface 106 may utilize an online and/or web-based application interface that may connect to a remote server via a connection to the Internet. For example, each of customer channel interface 102, call center interface 104, and/or agent channel interface 106 may facilitate a user connecting to a website that allows for the entry of relevant customer information.

In the present aspects in which software is executed on any of customer channel interface 102, call center interface 104, agent channel interface 106, and a remote device, any such interface may communicate with the remote device using one or more application programming interfaces (APIs). For example, if customer channel interface 102 is a mobile device, customer channel 102 may implement a locally installed application that facilitates the entry of customer information and utilizes one or more APIs to facilitate communication and/or transfer of this information to the remote device.

In the present aspect, the interface implemented by each of customer channel interface 102, call center interface 104, and agent channel interface 106 may be identical interfaces. For example, although customer channel 110, call center channel 118, and agent channel 124 represent different physical channels for sending customer information to a remote device, each of these channels' respective interfaces may implement the same application, such as a web-based application, for example, to do so.

In applying for an insurance policy and submitting the appropriate information via one of channels 110, 118, or 124, a customer may stop and wish to start the process up again at a later time. For example, the customer may use customer channel 110 at home from a personal computer, but may have questions or not have time to complete all necessary information in one session. Traditionally, a customer's progress in one channel might be saved, but lost when a customer wanted to switch to a different channel. For example, if a customer starting filling out an online form with customer information for one or more insurance policies, a customer might be able to save that information and pick up where he left off in a later online session, i.e., using the same channel. However, a customer that ended his online session at home and decided to go to an agents' office or contact a call center to complete the process may have to start the entire application process over and lose all progress.

To resolve this, the present aspects may provide a common application interface for each of channels 110, 118, and 124. Furthermore, the present aspects may include a remote device (e.g., a server) configured to save the customer's progress, flag the channel that was used by the customer to send the information, and/or store one or more indicators representative of any missing data needed to build a completed customer policy profile 108.

For example, as shown in FIG. 1, a customer may utilize customer channel interface 102 to enter customer information via customer channel 110. The customer may enter all necessary customer information using customer channel interface 102, or the customer may enter a portion of his information before deciding to call a call center, as indicated by arrows 112 and 114. Alternatively, the customer may decide to visit an agent's office after entering a portion of information using customer channel interface 102, as indicated by arrow 116. In addition, if the customer decides to call the call center, the customer may decide not to use the call center channel interface 104 and to instead visit an agent's office, as indicated by arrow 120. Furthermore, a customer may decide to enter another portion of customer information using call center channel interface 104 before deciding to visit the agent's office, as indicated by arrow 116. In any event, the user may enter any portion of customer information at any suitable time by submitting customer information via any of channels 110, 118, and/or 124 in accordance with their respective interfaces.

In the present aspects, a remote device may be configured to determine the remaining portion of information required to build completed customer policy profile 108, and to gather only this information from the customer at any of the other utilized channels. Once completed customer policy profile 108 may be generated, an appropriate insurance policy may be selected, and any suitable information regarding the selected insurance policy may be communicated back to the customer via the currently utilized channel.

In the present aspects, any suitable number and type of insurance policy may be requested from a customer via one or more of channels 110, 118, and/or 124. In the present aspect, any of customer channel interface device 202, call center channel interface device 250, and/or agent channel interface device 240 may be utilized by a customer to request an insurance policy, and any number of an insurer's complete suite of insurance policies may be offered via any of these interface devices, or limited based upon the interface device. In some of the present aspects, an insurer's complete suite of insurance products, which could include both life and non-life insurance policies, could be requested by a customer via one or more of channels 110, 118, and/or 124. In other present aspects, a customer's requests may be limited to a portion of the insurer's complete suite of insurance products based upon a particular channel. For example, an insurer may decide to steer a customer to an agent's office to complete a life-insurance policy request that was started by the customer through a customer channel, such as channel 110, for example.

Depending on the type of insurance policy (e.g., a life insurance policy versus a non-life insurance policy) that is requested by the customer, an insurer may prefer some channels over others. For example, in some present aspects, a customer may be prompted to complete an insurance policy in an agents' office. This could be particularly useful, for example, when the desired insurance policy is a life insurance policy, and the agent may be trained to sell the customer additional insurance products. In such a case, the customer information submitted by an agent via agent channel 124 may include one or more requests for additional policies, benefits, etc., regarding the additional life insurance services.

Examples of customer information that may be used to build completed customer policy profile 108 include any suitable relevant information used to make a determination regarding a type of insurance policy and the details associated with an insurance policy, such as risk factors and/or other information. For example, if a customer is requesting a life insurance policy, the customer information may include a customer's age, lifestyle habits, driving records, etc. Customer information may also include information regarding a desired type of policy requested by the customer, a call center operator, an agent and/or additional insurance services that might have been added on by the call center operator and/or agent during the insurance sales process.

The details associated with the insurance policy that are determined once the completed customer policy profile 108 is generated may include, for example, an insurance policy premium, an insurance type, an insurance coverage, an insurance benefit, an insurance beneficiary, an insurance term, etc. As will be appreciated by those of ordinary skill in the relevant art(s), the insurance details may be based upon the type of insurance policy requested (e.g., life, property, etc.). In the present aspects, the customer information and the relevant insurance details may be collected and/or generated regarding any suitable number of insurance policies.

In some of the present aspects, such as life insurance requests, for example, once completed customer policy profile 108 is generated, a customer may need to wait for a medical underwriting process to be completed before the insurance policy is actually issued. In such aspects, the details associated with the insurance policy that are determined once the completed customer policy profile 108 is generated may include, for example, a scheduled time slot for the customer to select for medical personnel to visit the customer, information regarding the limitations and/or start of coverage, various disclaimers, etc.

In other present aspects of life insurance requests, the customer may be immediately covered for some grace period. This grace period may be conditioned upon the customer completing the medical underwriting process but provides the customer with some coverage (which may be less than or equal to the applied coverage) until the medical underwriting process has completed. In accordance with the present aspect, the customer information collected and the details associated with the life insurance policy may include details regarding this grace period and corresponding coverage. In the present aspects, life insurance policies requested and/or issued in this way, which may include customer information collected from any suitable number of channels 110, 118, and/or 124, may be done in accordance with any suitable method as described in co-pending application identified by attorney docket number 32060/48526A, which is hereby incorporated by reference in its entirety.

Because the present aspects may utilize a common application interface for each channel, customer information may be collected uniformly and organized by each respective channel, thus allowing a remote device to identify and/or store previously entered customer information while prompting a user only for portions of customer information not yet stored. In this way, cross channel process 100 may provide increased efficiency and convenience to users by presenting a common application interface across different channels and storing the progress of a customer's information across each of these channels.

### II. Exemplary Cross Channel Network

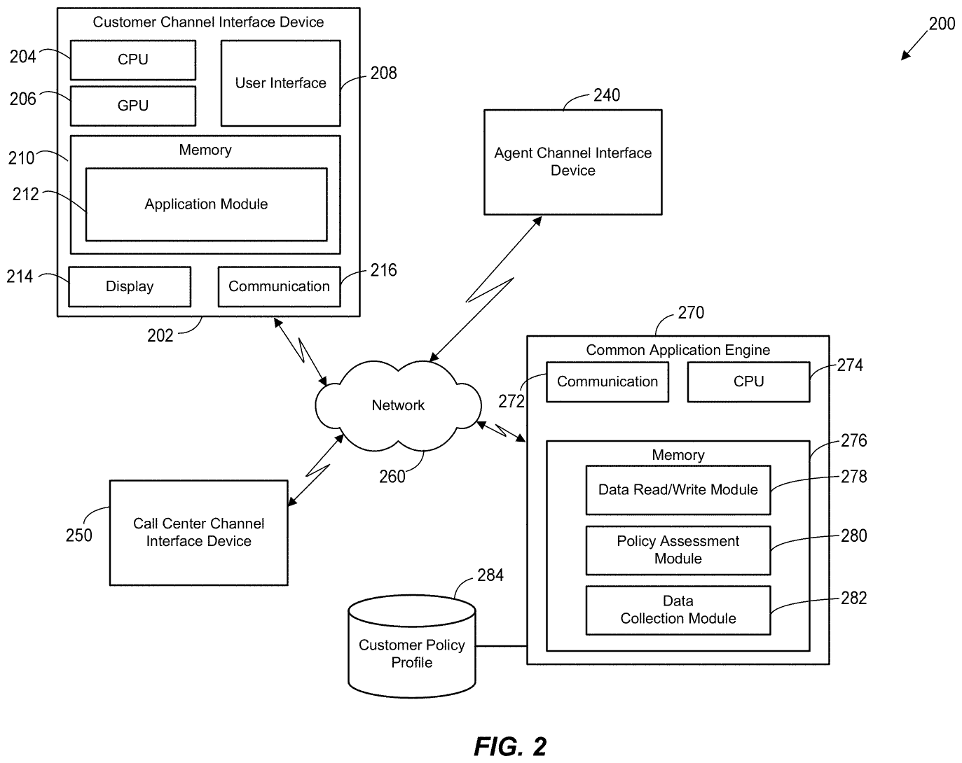

FIG. 2 is a block diagram of an exemplary cross channel network 200. Cross channel network 200 may include a customer channel interface device 202, a call center channel interface device 250, an agent channel interface device 240, and a common application engine 270. In the present aspect, customer channel interface device 202, call center channel interface device 250, and agent channel interface device 240 may be implementations of customer channel interface 102, call center interface 104, and agent channel interface 106, respectively. In the present aspect, common application engine 270 may be an implementation of a remote device, such as the remote device previously discussed, but not shown, in FIG. 1.

Customer channel interface device 202 may be configured to connect to common application engine 270 via a network 260. Network 260 may include any appropriate combination of wired and/or wireless communication networks. For example, network 260 may include any combination of a local area network (LAN), a metropolitan area network (MAN), a wide area network (WAN), public switched telephone networks (PSTN), and may facilitate a connection to the Internet. To provide further examples, network 260 may include wired telephone and cable hardware, satellite, cellular phone communication networks, etc.

Customer channel interface device 202 may include a central processing unit (CPU) 204, a graphics processing unit (GPU) 206, a user interface 208, a memory 210, a display 214, and a communication unit 216. In the present aspect, customer channel interface device 202 may be implemented as any suitable type of computing device, such as a UE, a mobile device, a computer, laptop, tablet, desktop, wearable electronic devices, etc.

CPU 204 and/or GPU 206 may be configured to communicate with memory 210 to store to, and read data from, memory 210. In accordance with the present aspects, memory 210 may be a computer-readable non-transitory storage device that may include any combination of volatile (e.g., a random access memory (RAM), or a non-volatile memory (e.g., battery-backed RAM, FLASH, etc.)). Memory 210 may be configured to store instructions executable on CPU 204 and/or GPU 206. These instructions may include machine readable instructions that, when executed by CPU 204 and/or GPU 206, cause CPU 204 and/or GPU 206 to perform various acts.

User interface 208 may be configured to allow a user to interact with customer channel interface device 202. For example, user interface 208 may include a user-input device such as an interactive portion of display 214 (e.g., a “soft” keyboard displayed on display 214), an external hardware keyboard configured to communicate with customer channel interface device 202 via a wired or a wireless connection (e.g., a BLUETOOTH keyboard), an external mouse, or any other suitable user-input device.

Communication unit 216 may be configured to enable data communications between customer channel interface device 202 and common application engine 270 via network 260. In the present aspect, communication unit 216 may be configured to send data, which may include customer information relevant for determining a type of insurance policy and details associated with the insurance policy, entered by a customer via user interface 208, to common application engine 270. For example, communication unit 216 may send a customer's desired insurance policy type, risk factors, and/or any other suitable relevant information used to determine an insurance policy type, premium, term, etc., to common application engine 270 via network 260.

In the present aspect, communication unit 216 may be configured to receive data, such as insurance policy details, from common application engine 270. For example, communication unit 216 may receive insurance policy premiums, a confirmation of coverage, disclaimers, etc., from common application engine 270 via network 260.

As will be appreciated by those of ordinary skill in the relevant art(s), communication unit 216 may be implemented with any combination of suitable hardware and/or software to facilitate this functionality. For example, communication unit 216 may be implemented with any number of wired and/or wireless transceivers, network interfaces, physical layers (PHY), etc. In aspects in which customer channel interface device 202 is a mobile device, communication unit 216 may enable communications with one or more networks, which may or may not be part of network 260. For example, communication unit 216 may be configured to communicate with cellular and/or WLAN networks in addition to network 260. Networks separate from network 260 are not shown in FIG. 1 for purposes of brevity.

Application module 212 may be a portion of memory 210 configured to store instructions, that when executed by CPU 204 and/or GPU 206, cause CPU 204 and/or GPU 206 to enable user interface 208 to collect user input and to display feedback to a user in accordance with one or more applications and/or programs. For example, executable instructions stored in application module 212 may enable user interface 208 to display one or more prompts to a user and/or to accept user input, which could include entering data into one or more data fields, for example. In the present aspect, instructions stored in application module 212 may enable a user to enter suitable data to enroll in one or more insurance policies.

Application module 212 may enable user interface 208 to facilitate sending data to another device, such as common application engine 270, for example, via communication unit 216. For example, application module 212 may include instructions that enable user interface 208 to collect relevant data from a user and then allow the user to submit the relevant data to common application engine 270 by clicking or pressing an appropriate interactive button. If a user previously used another channel interface device, such as call center channel interface device 250, for example, various aspects may include application module 212 having instructions that enable user interface 208 to prompt a user only for customer information that has not already been stored (i.e., entered by the customer) by common application engine 270.

In some of the present aspects, application module 212 may include a full application that may be downloaded and/or installed on customer channel interface device 202. In accordance with such aspects, application module 212 may provide standalone application functionality, and may minimally utilize communications with common application engine 270 to collect customer information and/or retrieve insurance policy details from common application engine 270.

In other present aspects, application module 212 may be implemented as part of a thin client device, and may rely more heavily (i.e., as compared to full application aspects) on communications with common application engine 270 to collect customer information and/or to retrieve insurance policy details from common application engine 270. As will be appreciated by those of ordinary skill in the relevant art(s), the present aspects of application module 212 may be utilized based upon a particular implementation of customer channel interface device 202.

Although FIG. 1 illustrates customer channel interface device 202 communicating with a single common application engine 270, the present aspects may include customer channel interface device 202 communicating with any suitable number of other application engines using any suitable number of networks.

In the present aspect, agent channel interface device 240 and call center channel interface device 250 may have substantially similar structure, features, and functionality as customer channel interface device 202. Therefore, only differences between these devices will be further described.

In the present aspects, customer channel interface device 202, agent channel interface device 240, and call center channel interface device 250 may implement respective application modules that include the same level or a different level of application functionality. For example, customer channel interface device 202 may implement application module 212 as part of a thin client device, while agent channel interface device 240 and call center channel interface device 250 implement respective application modules having standalone functionality.

In the present aspect, each of customer channel interface device 202, agent channel interface device 240, and call center channel interface device 250 may implement respective application modules that provide identical, or substantially identical, application processes for collecting customer information. For example, in the present aspect, each of customer channel interface device 202, agent channel interface device 240, and call center channel interface device 250 may present a user with the same application interface in which to enter customer information, which may then be sent to common application engine 270 by each respective interface device via a corresponding channel. In this way, a uniform application interface may be used for each interface device regardless of who is entering the information. By providing a uniform application interface, data sent via each channel may be easily aggregated since it may be formatted in accordance with the same application entry procedure.

As will be appreciated by those of ordinary skill in the relevant art(s), subtle variations between application interfaces may be present without departing the spirit and scope of the present disclosure. For example, call center channel interface device 250 and/or agent channel interface device 240 may incorporate additional application interface features that are not implemented by customer channel interface device 202. To provide illustrative examples, call center channel interface device 250 and/or agent channel interface device 240 may implement additional features specific to collecting data from a customer over each respective channel. This may include entry of information to appropriately identify the customer, entry of a customer account, an insurer employee secure login, etc. Regardless of these differences, the present aspects may include each of customer channel interface device 202, agent channel interface device 240, and call center channel interface device 250 providing a core common application that may collect customer information in the same format and send the customer information to common application engine 270.

In the present aspects, common application engine 270 may be implemented as any suitable type of server, such as an application server, a database server, a standalone sever, a web-based server, and/or as any suitable type of computing device, such as a computer, a smartphone, a laptop, a cloud-based computing device, etc.

In the present aspects, communication unit 272 may be configured to enable data communications between common application engine 270 and one or more of customer channel interface device 202, agent channel interface device 240, and call center channel interface device 250 via network 260. Again, this data could include any suitable relevant customer information, for example, sent from one or more of customer channel interface device 202, agent channel interface device 240, and call center channel interface device 250 via their respective channels for enrollment in one or more insurance policies.

In the present aspect, CPU 274 may be configured to communicate with memory 276 to store to and read data from memory 276. In accordance with the present aspects, memory 276 may be a computer-readable non-transitory storage device that may include any combination of volatile (e.g., a random access memory (RAM), or non-volatile memory (e.g., battery-backed RAM, FLASH, etc.). Memory 276 may be configured to store instructions executable by CPU 274. These instructions may include machine readable instructions that, when executed by CPU 274, cause CPU 274 to perform various acts.

Data read/write module 278, policy assessment module 280, and data collection module 282 are portions of memory 276 that may be configured to store instructions executable by CPU 274. In the present aspect, data read/write module 278 may include instructions that, when executed by CPU 274, causes CPU 274 to read data from and/or to write data to customer policy profile database 284. In the present aspect, data read/write module 278 may enable CPU 274 to access customer policy profile database 284 to determine a remaining portion of customer information that is needed to complete a customer policy profile, and thus determine one or more insurance policies in which to enroll the customer and any suitable associated details of such policies. In the present aspects, data read/write module 278 may enable CPU 274 to query data from customer policy profile database 284 and/or to store this data in memory 276. Further in accordance with this aspect, data read/write module 278 includes instructions that enable CPU 274 to access stored data from memory 276 when executing instructions from policy assessment module 280 and/or data collection module 282.

Data collection module 282 may include instructions that, when executed by CPU 274, causes CPU 274 to store and/or aggregate data, such as customer information, received via one or more channels. For example, if a customer starts an insurance application process online using customer channel interface device 202 and then finishes the application process using call center channel interface device 250, data collection module 282 may include instructions that enable CPU 274 to merge data collected from each of these channels into a complete customer information.

Data collection module 282 may include instructions that, when executed by CPU 274, causes CPU 274 to store one or more flags and/or indicators in memory 276 and/or customer policy profile database 284. These flags and/or indicators may be represented in any suitable data format, and may allow for the identification of a channel from which data was received. Additionally or alternatively, these flags and/or indicators may enable CPU 274 to match a partial customer policy profile to the correct customer when the customer sends in additional customer information via one or more additional channels.

For example, in the present aspects, data collection module 282 may include instructions that allow CPU 274 to match an associated customer profile stored in customer policy profile database 284 with additional customer information received via one or more additional channels. For example, using the previous example, when a customer starts an application process online using customer channel interface device 202 and finishes the application process using call center channel interface device 250, the present aspects may include data collection module 282 having instructions that allow CPU 274 to match customer information received via the call center channel to the information received from the online customer channel. As will be appreciated by those of ordinary skill in the relevant art(s), this matching process may be implemented using any suitable database entry matching system, such as looking up a customer identification number, login, last name and phone number, etc.

Data collection module 282 may include instructions that, when executed by CPU 274, causes CPU 274 to flag data by channel using any suitable process, such as, for example, a string of text, a numeric identifier, an IP address, etc., that appropriately identifies the source of customer information. Aspects whereby data is identified by channel source may be particularly useful, when, for example, minor variations between application interfaces may result in a difference between data formats received via each channel. Such aspects may allow CPU 274 to reformat the multi-channel data received from one or more channels efficiently and accurately and to aggregate the multi-channel data into a single complete customer policy profile.

Additionally or alternatively, data collection module 282 may include instructions that, when executed by CPU 274, may cause CPU 274 to flag and/or identify whether enough customer information has been collected to complete the policy enrollment process and. In accordance with such aspects, one or more suitable identifiers may be implemented indicating a remaining amount of information that is still required to do so. As will be appreciated by those of ordinary skill in the relevant art(s), the determination of whether complete customer information has been collected may be implemented using any suitable progression identification system, such as comparing and/or correlating mandatory field answers with the information previously received and stored in customer policy profile database 284, for example.

Policy assessment module 280 may include instructions that, when executed by CPU 274, may cause CPU 274 to determine which policies a customer is qualified to enroll in, whether to enroll a customer in one or more insurance policies, and to determine the associated details for one or more qualified and/or enrolled insurance policies. These calculations could be based upon, for example, a risk assessment algorithm that utilizes relevant customer information such as lifestyle choices, age, etc., to determine whether the customer is qualified for one or more insurance policies and/or associated details of each policy, such as premiums, terms, limitations, benefits, disclaimers, etc. As will be appreciated by those of ordinary skill in the relevant art(s), a risk assessment algorithm may be tailored based upon a particular set of data and/or assessed risk.

In the present aspects, customer policy profile database 284 may be implemented within common application engine 270, separate from common application engine 270, or external to common application engine 270.

In accordance with the present aspects, any of assessment module 212, data read/write module 278, policy assessment module 280, and data collection module 282 may operate as a separately executable software application, a plugin that extends the functionality of another software application such as a web browser, an application programming interface (API) invokable by a software application, etc. The instructions included within any of assessment module 212, data read/write module 278, policy assessment module 280, and/or data collection module 282 may be compiled and executable on their respective CPUs directly, or not compiled and interpreted by their respective CPUs on a runtime basis.

FIG. 2 illustrates common application engine 270 coupled to customer policy profile database 284 for purposes of brevity. As will be appreciated by those of ordinary skill in the relevant art(s), the present aspects of common application engine 270 may include common application engine 270 accessing customer policy profile database 284 via any suitable network, which may be substantially similar to network 260, for example. In accordance with such aspects, common application engine 270 may be configured to access customer policy profile database 284 via a network such that customer policy profile database 284 and common application engine 270 need not be co-located. For example, in accordance with such aspects, common application engine 270 may access customer policy profile database 284 via a connection to the Internet to download relevant customer information. To provide another example, common application engine 270 may access customer policy profile database 284 via a local, secure connection to one or more private servers to download relevant premium quoting information.

Although illustrated as a single engine in FIG. 2, in the present aspects, common application engine 270 may be implemented with any number or group of application engines. In accordance with such aspects, each application engine may include one or more CPUs and be configured to operate independently of the other application engines. Application engines operating as a group may process requests from any suitable number of customers via various channels individually (e.g., based upon their availability) and/or concurrently (e.g., parallel processing). Application engines operating as a group may process data received from one or more channels in a prioritized and/or distributed manner. For example, an operation associated with processing a request may be performed on one application engine while another operation associated with processing the same request (or a different request) is performed on another application engine.

### III. Exemplary Cross Channel Method

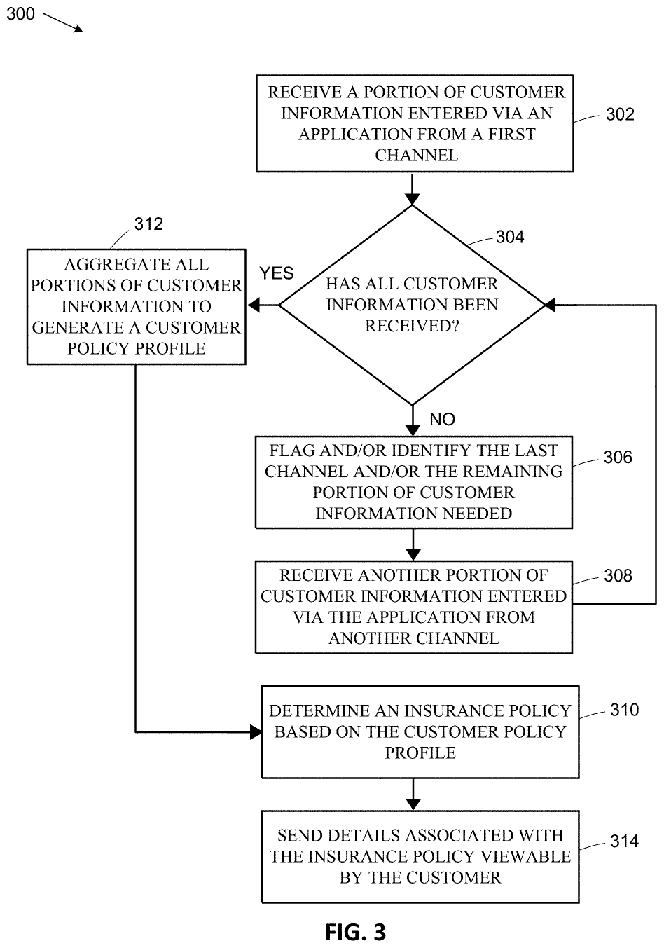

FIG. 3 illustrates an exemplary method 300. In one aspect, method 300 may be implemented as a part of a cross channel process 100, as shown in FIG. 1 and/or by a common application engine, such as common application engine 270, for example, as shown in FIG. 2.

Method 300 may start when one or more processors may receive a portion of customer information entered via an application from a first channel (block 302). These one or more processors could include a CPU, such as CPU 274, for example, as shown in FIG. 2, which may receive the customer information in conjunction with a communication unit, such as communication unit 272, for example. The first portion of customer information may include customer information entered by a user via an application that is sent via a first channel, such as an application executed from instructions stored in application module 212, as shown in FIG. 2, for example, from a channel interface device, such as customer channel interface device 202, for example, and submitted via a customer channel.

Method 300 may include determining whether customer information has been received that is adequate to determine a customer's qualifying insurance policies and/or detailed information that may be associated with those policies (block 304). This may include, for example, retrieving customer information from a database, such as customer policy profile database 284, as shown in FIG. 2, and determining whether additional customer information is needed. If additional customer information is needed, method 300 may continue (block 306). If no additional customer information is needed, method 300 may continue (block 312).

Method 300 may include flagging and/or identifying the received data with the previously received data and/or storing an indication of the remaining customer information needed to complete the customer policy profile (block 306). For example, if a customer initially enters customer information via a first channel, such as a customer channel, and then enters additional information via a second channel, such as a call-center channel, (block 306) method 300 may include, for example, flagging the data received from the customer channel so it may later be identified when additional data is collected via the call center channel.

Additionally or alternatively, method 300 may include storing an indication of the remaining customer information that is needed, i.e., the information still missing that is needed to complete the customer policy profile (block 306). In some aspects, one or more portions of block 306 may be omitted, which may include block 306 in its entirety. For example, flagging received data by corresponding channel may not be necessary when identical applications are used for data collection in each channel, since data received via each channel may be formatted in the same way.

Additional portions of customer information may be received via one or more additional channels. Using the previous example, this may include receiving the remaining portion of customer data via a call center channel necessary to build the complete customer policy profile, in the present aspect. Once data is collected via another channel, insurance issuance method 300 may revert back to block 304. If it is determined that additional data is still needed to build a complete customer policy profile (block 304), then method 300 may repeat flagging and/or identifying the last channel and/or the remaining portion of customer information that is needed (block 306) and/or receiving additional portions of customer information from an additional channel (block 308) as needed until a complete customer policy profile is collected over additional channels, which may be different than or the same as the initial two channels.

For example, if, after entering customer information from a call center channel customer channel, a customer then decides to visit an agent's office to complete the enrollment process, method 300 may include a determination being made that additional customer data is still needed (block 304). In such a case, method 300 may include optionally flagging data received via the call center channel (block 304) and/or indicating a remaining portion of customer data that is still needed to build a complete customer policy profile (block 304). Once the necessary data is collected to build a complete customer policy profile, method 300 may continue (block 312).

Method 300 may include aggregating all portions of customer information received over any suitable number of channels into a complete customer policy profile (block 312). This may include, for example, assembling and/or parsing the customer information received via one or more of the channels into a consolidated customer profile, which may include, for example, a single computer-readable file, in the present aspect.

Method 300 may include determining which insurance policies are available to the customer and/or the details associated with these policies (block 310). This may include, for example, execution of one or more risk assessment algorithms to determine whether a customer qualifies for enrollment in one or more insurance policies based upon the complete customer policy profile and/or a calculation of premiums, deductibles, and/or any other relevant details that may be useful to the customer regarding such insurance policies (block 310).

Method 300 may include sending the details associated with the policies (block 314) previously determined (block 310) so they may be subsequently viewed by the customer (block 314). This may include, for example, sending the details back to the customer in accordance with the channel and/or application interface last used by the customer that resulted in completion of the customer policy profile, in one aspect (block 314). Method 300 may include additional, fewer, or alternate actions, including those discussed elsewhere herein.

### IV. Exemplary Method of Generating an Insurance Policy

In one aspect, a computer-implemented method for collecting information for issuance of a life insurance policy may be provided. The method may include (1) receiving, by one or more processors, a first portion of customer information entered by one or more users via a first application over a first channel; (2) receiving, by one or more processors, a second portion of customer information entered by one or more users via a second application over a second channel; (3) aggregating, by one or more processors, the first and second portion of customer information to generate an aggregated customer policy profile; and (4) determining, by one or more processors, a life insurance policy based upon the aggregated customer policy profile. The first and the second application may be identical, or nearly identical, web-based applications. The method may include additional, fewer, or alternate actions, including those discussed elsewhere herein.

For example, the method may include sending, by one or more processors, details associated with the life insurance policy through the second channel to allow a user to view the details using the second application. The first and second channels may be from among one or more of: (1) a customer channel; (2) a call center channel; and (3) an insurance agent channel, the first channel being different than the second channel. The act of sending may include: sending, as the details associated with the life insurance policy, one or more of: (1) a life insurance policy premium; (2) a life insurance type; (3) a life insurance coverage; (4) a life insurance benefit; (5) a life insurance beneficiary; and (6) a life insurance term.

The method may include (1) storing, by one or more processors, the first portion of customer information as a first stored portion of customer information; (2) storing, by one or more processors, a flag indicating that the first portion of customer information was received via the first channel and how much of the aggregated customer policy profile is represented by the first stored portion of customer information; and (3) causing, by one or more processors, the second application to prompt a user for the second portion of customer information, based upon the flag, to complete the aggregated customer policy profile.

The act of receiving the first and the second portions of customer information may include receiving life insurance policy customer information and non-life insurance policy customer information. In such a case, the method may include determining a non-life insurance policy based upon the aggregated customer policy profile.

The method may further include receiving, by one or more processors, a third portion of customer information entered via a third application from a third channel. The act of aggregating may include aggregating the first portion, the second portion, and the third portion of customer information to generate the aggregated customer policy profile, and the first application, the second application, and the third application may be identical, or nearly identical, web-based applications.

### V. Exemplary Non-Transitory Medium

In one aspect, a non-transitory, tangible computer-readable medium storing machine readable instructions may be provided. The instructions, when executed by a processor, may cause the processor to: (1) receive a first portion of customer information entered by one or more users via a first application over a first channel; (2) receive a second portion of customer information entered by one or more users via a second application over a second channel; (3) aggregate the first and second portion of customer information to generate an aggregated customer policy profile; and/or (4) determine a life insurance policy based upon the aggregated customer policy profile. The first and the second application may be identical, or nearly identical, web-based applications. The machine readable instructions may include additional, less, or alternate functionality, including that discussed elsewhere herein.

The instructions may cause the processor to send details associated with the life insurance policy through the second channel to allow a user to view the details using the second application. The instructions may cause the processor to receive the first and second portions of customer information from one or more of: (1) a customer channel; (2) a call center channel; and (3) an insurance agent channel. The first channel may be different than the second channel. The instructions to send the details associated with the life insurance policy through the second channel include instructions that when executed by the processor, may cause the processor to send, as the details associated with the life insurance policy, one or more of: (1) a life insurance policy premium; (2) a life insurance type; (3) a life insurance coverage; (4) a life insurance benefit; (5) a life insurance beneficiary; and (6) a life insurance term.

The instructions may cause the processor to (1) store the first portion of customer information as a first stored portion of customer information; (2) store a flag indicating that the first portion of customer information was received via the first channel and how much of the aggregated customer policy profile is represented by the first stored portion of customer information; and/or (3) cause the second application to prompt a user for the second portion of customer information, based upon the flag, to complete the aggregated customer policy profile. The first and second portions of customer information may include life insurance policy customer information and non-life insurance policy customer information. In such a case, the instructions, when executed by the processor, may cause the processor to determine a non-life insurance policy based upon the aggregated customer policy profile.

The instructions may cause the processor to receive a third portion of customer information entered by one or more users via a third application over a third channel, and the instructions that cause the processor to aggregate the first and second portions of customer information includes instructions that cause the processor to: aggregate the first portion, the second portion, and the third portion of customer information to generate the aggregated customer policy profile. The first application, the second application, and the third application may identical, or nearly identical, web-based applications.

### VI. Exemplary Common Application Engine

In one aspect, a common application engine is described for collecting information for issuance of a life insurance policy. The common application engine may include a communication unit configured to receive (1) a first portion of customer information entered by one or more users via a first application and received over a first channel and (2) a second portion of customer information entered by one or more users via a second application and received over a second channel. The common application engine may also include a central processing unit (CPU) that is configured to aggregate the first and second portion of customer information to generate an aggregated customer policy profile, and to determine a life insurance policy based upon the aggregated customer policy profile. The first and the second applications may be identical, or nearly identical, web-based applications. The common application engine may be configured for additional, less, or alternate functionality, including that discussed elsewhere herein.

For example, the communication unit may send details associated with the life insurance policy through the second channel to allow a user to view the details using the second application. The first and second channels may be from among one or more of: (1) a customer channel; (2) a call center channel; and (3) an insurance agent channel, and the first channel may be different than the second channel. The act of sending may include: sending, as the details associated with the life insurance policy, one or more of: (1) a life insurance policy premium; (2) a life insurance type; (3) a life insurance coverage; (4) a life insurance benefit; (5) a life insurance beneficiary; and (6) a life insurance term.

The CPU may (1) store the first portion of customer information as a first stored portion of customer information; (2) store a flag indicating that the first portion of customer information was received via the first channel and how much of the aggregated customer policy profile is represented by the first stored portion of customer information; and (3) cause the second application to prompt a user for the second portion of customer information, based upon the flag, to complete the aggregated customer policy profile.

The first portion and the second portions of customer information may include both life insurance policy customer information and non-life insurance policy customer information. In such a case, the CPU may determine a non-life insurance policy based upon the aggregated customer policy profile.

The communication unit may receive a third portion of customer information entered by one or more users via a third application, which is received from a third channel. In such a case, the CPU may aggregate the first portion, the second portion, and the third portion of customer information to generate an aggregated customer policy profile. The first application, the second application, and the third application may be identical, or nearly identical, web-based applications.

### VII. Additional Considerations

Although the present disclosure has been explained with reference to three channels, aspects of the disclosure include collecting and aggregating customer information received over any suitable number of channels. For example, additional channels within the spirit and scope of the present disclosure but not illustrated could include channels such as faxing customer information, mailing customer information, emailing customer information, etc. In accordance with aspects that utilize these additional channels, any suitable process may be utilized to convert the customer information received via these channels into a recognizable format for use by a remote device, such as common application engine 270, for example, as shown in FIG. 2. Examples of suitable methods may include scanning, parsing, and/or recognition of customer information, such as by optical character recognition (OCR) processes, etc.

Furthermore, the following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain aspects are described herein as including logic or a number of components or modules. Modules may constitute either software modules (e.g., code stored on a machine-readable medium) or hardware modules. A hardware module may be a tangible unit capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In some cases, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering aspects in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In aspects in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example aspects, the processor or processors may be located in a single location (e.g., within a home environment, an office environment or as a server farm), while in other aspects the processors may be distributed across a number of locations.

The one or more processors may also operate to support performance of the relevant operations in a “cloud computing” environment or as a SaaS. For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other example aspects, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect is included in at least one aspect. The appearances of the phrase “in one aspect” in various places in the specification are not necessarily all referring to the same aspect.

Some aspects may be described using the expression “coupled” and “connected” along with their derivatives. For example, some aspects may be described using the term “coupled” to indicate that two or more elements are in direct physical or electrical contact. The term “coupled,” however, may also mean that two or more elements are not in direct contact with each other, but yet still co-operate or interact with each other. The aspects are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, condition A or B is satisfied by any one of the following: A is true (or present) and B is false (or not present), A is false (or not present) and B is true (or present), and both A and B are true (or present).

In addition, use of the “a” or “an” are employed to describe elements and components of the aspects herein. This is done merely for convenience and to give a general sense of the description. This description should be read to include one or at least one and the singular also includes the plural unless it is obvious that it is meant otherwise.

Although the forgoing text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

Upon reading this disclosure, those of skill in the art will appreciate still additional alternative structural and functional designs for providing an interface to facilitate collecting information from a customer via various channels and generating an insurance quote based upon this information through the disclosed principles herein. Thus, while particular aspects and applications have been illustrated and described, it is to be understood that the disclosed aspects are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

For example, although the present disclosure explains and illustrates exemplary aspects in the context of the issuance of life insurance policies, those of ordinary skill in the relevant art(s) will appreciate that the aspects described throughout the present disclosure may be applied to any suitable type of product that processes data collected from a customer via one or more communication channels to determine whether the customer qualifies for the product through any suitable type of assessment based upon the collected data.

Some examples of such alternate applications may include other types of insurance products, such as property and casualty insurance, for example, and/or non-insurance products. Some examples of alternate non-insurance products may include those related to the financial and healthcare industries, such as banking applications, new account requests, loan processing, credit checks and/or requests, healthcare products, etc.

In accordance with such alternate aspects, those of ordinary skill in the relevant art(s) will also appreciate that risk assessment algorithms may be replaced or modified to include one or more other suitable types of assessment algorithms based upon the particular assessment that is to be made for the relevant product, such as a determination of whether a customer's credit score meets or exceeds a credit threshold, whether a customer has a number of delinquent accounts in excess of a threshold number, whether a customer has a debt-to-income ratio beneath a threshold ratio, etc.

1. A client-server based method for coalescing multi-channel information for generation of a policy profile from multi-channel customer data, the method comprising:
receiving via a computer network, at a common application engine, a first incomplete portion of user information entered via a first application of a first client device from a first communication channel at a first time, the first incomplete portion of user information being formatted with a first communication channel format;
storing, with the common application engine, a first communication channel flag indicating that the first incomplete portion of user information was received from the first communication channel and was formatted with the first communication channel format;
receiving via the computer network, at the common application engine, a second incomplete portion of user information entered via a second application of a second client device from a second communication channel at a second time following the first time, the second incomplete portion of user information being formatted with a second communication channel format, wherein the second incomplete portion of user information is different from the first incomplete portion of user information, and wherein the first communication channel and the first communication channel format is different from the second communication channel and the second communication channel format;
storing, with the common application engine, a second communication channel flag indicating that the second incomplete portion of user information was received from the second communication channel and was formatted with the second communication channel format;
generating, by the common application engine, a common data set comprising reformatted data from the first incomplete portion of user information and the second incomplete portion of use information by:
reformatting, with a data collection module of the common application engine, based on the first communication channel flag, the first incomplete portion of user information to have a multi-channel data server format; and
reformatting, with a data collection module of the common application engine, based on the second communication channel flag, the second incomplete portion of user information to have the multi-channel data server format;
generating, with the common application engine, a consolidated customer profile based upon the common data set in the multi-channel data server format;
determining, with the common application engine, that the user qualifies for a product based upon the generated consolidated customer profile, the product being at least one of an insurance product or a non-insurance product;
formatting, by the common application engine, one or more details of the new consolidated customer profile for transmission to and display on a user interface (UI) of the second client device in accordance with the second communication channel format as last used to complete the generated consolidated customer profile; and
transmitting, by the common application engine, the one or more details as formatted to the second client device via the second communication channel for rendering on the UI of the second client device as last used to complete the generated consolidated customer profile.

2. The method of claim 1, further comprising:
transmitting, from the common application engine, details associated with the product through the second communication channel to allow a user to view the details using the second application.

3. (canceled)

4. The method of claim 2, wherein the act of transmitting comprises:
transmitting, as the details associated with the product, one or more of:
a life insurance policy premium;
a life insurance type;
a life insurance coverage;
a life insurance benefit;
a life insurance beneficiary; and
a life insurance term.

5. The method of claim 2, wherein the act of determining the product includes determining one or more available types of insurance policies based upon a type of channel associated with the first communication channel.

6. The method of claim 1, wherein the act of receiving the first incomplete portion of user information comprises:
receiving life insurance policy user information and non-life insurance policy user information as the first incomplete portion of user information, and
wherein the act of receiving the second incomplete portion of user information comprises:
receiving life insurance policy user information and non-life insurance policy user information as the second incomplete portion of user information, and further comprising:
determining a non-life insurance policy based upon the first incomplete portion of user information as reformatted and the second incomplete portion of user information as reformatted.

7. The method of claim 1, further comprising:
receiving, by one or more processors, a third incomplete portion of user information entered via a third application of a third client device from a third communication channel at a third time, the third incomplete portion of user information including a third communication channel format,
storing, with the common application engine, a third communication channel flag indicating that the third incomplete portion of user information was received from the third communication channel;
reformatting, with a data collection module of the common application engine, based on the third communication channel flag, the third incomplete portion of user information to have the multi-channel data server format;
updating, with a data collection module of the common application engine, the consolidated customer profile based upon the third incomplete portion of user information as reformatted.

8. A non-transitory, tangible computer-readable medium storing machine readable instructions that, when executed by a processor, cause the processor to:
receive via a computer network, at a common application engine, a first incomplete portion of user information entered via a first application of a first client device from a first communication channel at a first time, the first incomplete portion of user information being formatted with a first communication channel format;
store, with the common application engine, a first communication channel flag indicating that the first incomplete portion of user information was received from the first communication channel and was formatted with the first communication channel format;
receive via the computer network, at the common application engine, a second incomplete portion of user information entered via a second application of a second client device from a second communication channel at a second time following the first time, the second incomplete portion of user information being formatted with a second communication channel format, wherein the second incomplete portion of user information is different from the first incomplete portion of user information, and wherein the first communication channel and the first communication channel format is different from the second communication channel and the second communication channel format;
store, with the common application engine, a second communication channel flag indicating that the second incomplete portion of user information was received from the second communication channel and was formatted with the second communication channel format;
generate, with the common application engine, a common data set comprising reformatted data from the first incomplete portion of user information and the second incomplete portion of use information by:
reformatting, with a data collection module of the common application engine, based on the first communication channel flag, the first incomplete portion of user information to have a multi-channel data server format; and
reformatting, with a data collection module of the common application engine, based on the second communication channel flag, the second incomplete portion of user information to have the multi-channel data server format;
generate, with the common application engine, a consolidated customer profile based upon the common data set in the multi-channel data server format;
determine, with the common application engine, that the user qualifies for a product based upon the generated consolidated customer profile, the product being at least one of an insurance product or a non-insurance product;
format, with the common application engine, one or more details of the new consolidated customer profile for transmission to and display on a user interface (UI) of the second client device in accordance with the second communication channel format as last used to complete the generated consolidated customer profile; and
transmit, with the common application engine, the one or more details as formatted to the second client device via the second communication channel for rendering on the UI of the second client device as last used to complete the generated consolidated customer profile.

9. The non-transitory, tangible computer-readable medium storing machine readable instructions of claim 8, further including instructions that when executed by a processor, cause the processor to:
transmit details associated with the product through the second channel to allow a user to view the details using the second application.

10. (canceled)

11. The non-transitory, tangible computer-readable medium storing machine readable instructions of claim 9, wherein the instructions to transmit the details associated with the product through the second communication channel include instructions that when executed by the processor, cause the processor to transmit, as the details associated with the product, one or more of:
a life insurance policy premium;
a life insurance type;
a life insurance coverage;
a life insurance benefit;
a life insurance beneficiary; and
a life insurance term.

12. The non-transitory, tangible computer-readable medium storing machine readable instructions of claim 8, wherein the instruction to determine the product includes instructions to determine one or more available types of insurance policies based upon a type of channel associated with the first communication channel.

13. The non-transitory, tangible computer-readable medium storing machine readable instructions of claim 8, wherein the instructions that when executed by the processor, cause the processor to receive the first incomplete portion of user information include instructions that cause the processor to:
receive life insurance policy user information and non-life insurance policy user information as the first incomplete portion of user information, and
wherein the instructions to cause the processor to receive the second incomplete portion of user information include instructions to cause the processor to:
receive life insurance policy user information and non-life insurance policy information as the second incomplete portion of user information, and further including instructions that that when executed by the processor, cause the processor to:
determine a non-life insurance policy based upon the first incomplete portion of user information as reformatted and the second incomplete portion of user information as reformatted.

14. The non-transitory, tangible computer-readable medium storing machine readable instructions of claim 8, further including instructions that when executed by the processor, cause the processor to:
receive a third incomplete portion of user information entered via a third application of a third client device from a third communication channel at a third time, the third incomplete portion of user information including a third communication channel format;
store, with the common application engine, a third communication channel flag indicating that the third incomplete portion of user information was received from the third channel;
reformat, with a data collection module of the common application engine, based on the third communication channel flag, the third incomplete portion of user information to have the multi-channel data server format; and
update, with a data collection module of the common application engine, the consolidated customer profile based upon the third incomplete portion of user information as reformatted.

15. A common client-server based application engine for coalescing multi-channel information for generation of a policy profile from multi-channel customer data, comprising:
a common application engine;
a data collection module communicatively coupled the common application engine; and
a communication unit communicatively coupled to the common application engine, the communication unit configured to receive, at the common application engine, a first incomplete portion of user information entered via a first application of a first client device from a first communication channel at a first time, the first incomplete portion of user information being formatted with a first communication channel format, and the communication unit configured to receive, at the common application engine, a second incomplete portion of user information entered via a second application of a second client device from a second communication channel at a second time following the first time, the second incomplete portion of user information being formatted with a second communication channel format,
wherein the first communication channel and the first communication channel format is different from the second communication channel and the second communication channel format, and
wherein the common application engine is configured to:
store the indication of remaining user information that is needed to complete a consolidated customer profile in addition to the first portion of user information;
cause the second application to transmit a prompt for a remaining portion of user information to complete the consolidated customer profile based upon the indication of remaining user information;
store, with the common application engine, a first communication channel flag indicating that the first incomplete portion of user information was received from the first communication channel and was formatted with the first communication channel format;
store, with the common application engine, a second communication channel flag indicating that the second incomplete portion of user information was received from the second communication channel and was formatted with the second communication channel format;
generate, with the common application engine, a common data set comprising reformatted data from the first incomplete portion of user information and the second incomplete portion of use information by:
reformatting, with a data collection module, based on the first communication channel flag, the first incomplete portion of user information to have a multi-channel data server format; and
reformatting, with a data collection module, based on the second communication channel flag, the second incomplete portion of user information to have the multi-channel data server format;
generate, with the common application engine the consolidated customer profile based upon the common data set in the multi-channel data server format;
determine, with the common application engine, that the user qualifies for a product based upon the generated consolidated customer profile, the product being at least one of an insurance product or a non-insurance product;
format, with the common application engine, one or more details of the new consolidated customer profile for transmission to and display on a user interface (UI) of the second client device in accordance with the second communication channel format as last used to complete the generated consolidated customer profile; and
transmit, with the common application engine, the one or more details as formatted to the second client device for rendering on the UI of the second client device as last used to complete the generated consolidated customer profile.

16. The common client-server based application engine of claim 15, wherein the communication unit is further configured to:
transmit details associated with the product through the second communication channel to allow a user to view the details using the second application.

17. (canceled)

18. The common client-server based application engine of claim 16, wherein the communication unit is further configured to transmit, as the details associated with the product, one or more of:
a life insurance policy premium;
a life insurance type;
a life insurance coverage;
a life insurance benefit;
a life insurance beneficiary; and
a life insurance term.

19. The common client-server based application engine of claim 16, wherein determining the product includes determining one or more available types of insurance policies based upon a type of channel associated with the first communication channel.

20. The common client-server based application engine of claim 15, wherein the communication unit is further configured to receive life insurance policy user information and non-life insurance policy user information as the first incomplete portion of user information, and to receive life insurance policy user information and non-life insurance policy user information as the second incomplete portion of user information, and wherein the common application engine is further configured to determine a non-life insurance policy based upon the first incomplete portion of user information as reformatted and the second incomplete portion of user information as reformatted.

21. The common client-server based application engine of claim 15, wherein the communication unit is further configured to receive a third incomplete portion of user information entered via a third application of a third client device from a third communication channel at a third time, the third incomplete portion of user information including a third communication channel format, storing, with the common application engine, a third communication channel flag indicating that the third incomplete portion of user information was received from the third communication channel,
reformatting, with a data collection module, based on the third communication channel flag, the third incomplete portion of user information to have the multi-channel data server format, and
updating, with the common application engine, the consolidated customer profile based upon the third incomplete portion of user information as reformatted.
